(19) United States
(12) Patent Application Publication
(10) Pub. No.: US 2008/0269390 A1
(43) Pub. Date: Oct. 30, 2008

(54) Dispersion Powders Containing Fatty Acid Anhydrides

(75) Inventor: Hans-Peter Weitzel, Reischach (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 12/091,110

(22) PCT Filed: Oct. 11, 2006
(86) PCT No.: PCT/EP2006/067289

§ 371 Date: Apr. 22, 2008

(30) Foreign Application Priority Data
Oct. 27, 2005 (DE) 10 2005 051 589.4

(51) Int. Cl. C08K 5/109

(52) U.S. Cl. 524/300

(57) ABSTRACT

The invention relates to water-redispersible polymer powder compositions containing from 0.1 to 70% by weight of one or more fatty acid anhydrides, based on the total weight of the polymer powder composition, and the use of these powders in hydraulically setting systems.

The invention relates to water-redispersible polymer powder compositions containing fatty acid anhydrides and the use of these powders in hydraulically setting systems.

Polymers based on vinyl esters, vinyl chloride, (meth)acrylate monomers, styrene, butadiene and ethylene are used, especially in the form of their aqueous dispersions or water-redispersible polymer powders, in many applications, for example as coating compositions or adhesives for a wide variety of substrates. To hydrophobicize the mineral compositions, these dispersion powders generally contain fatty acid esters and/or silanes.

EP 1193287 A2 relates to the use of powder compositions comprising at least one carboxylic ester for hydrophobicizing building compositions. WO 02/30846 A1 discloses granulated materials for hydrophobicization which contain fatty acids or fatty acid esters, if desired in combination with organopoly-siloxanes, applied to carrier particles. Water-redispersible, hydrophobicizing additives which contain fatty acids or fatty acid esters are described in WO 2004/103928 A1.

When the free fatty acid is used, there is frequently the danger that the mineral composition will become stiff prematurely and no longer remain processible. The same danger exists when the corresponding alkali metal or alkaline earth metal salts of the fatty acids are used. To avoid these problems, recourse is frequently made to the use of esters of fatty acids. These are typically methyl or ethyl esters or esters of low molecular weight polyalkylene glycols such as ethylene glycol, diethylene glycol and similar compounds. All these compounds hydrolyse under alkaline conditions and therefore have a hydrophobicizing action but at the same time liberate undesirable emission-relevant substances such as methanol, ethanol or ethylene glycol.

It was therefore an object of the invention to develop a dispersion powder which avoids the disadvantages of the prior art.

The invention provides water-redispersible polymer powder compositions containing from 0.1 to 70% by weight of one or more fatty acid anhydrides, based on the total weight of the polymer powder composition.

Suitable fatty acid anhydrides are those of branched or unbranched, saturated or unsaturated fatty acids having, in each case, from 8 to 22 carbon atoms. It is also possible to use mixed (unsymmetrical) anhydrides of the abovementioned fatty acids. It is likewise possible to use mixed anhydrides of the abovementioned fatty acids with carboxylic acids having from 2 to 6 carbon atoms, e.g. acetic acid or propionic acid. Preference is given to symmetrical fatty acid anhydrides. Particular preference is given to symmetrical fatty acid anhydrides of saturated or unsaturated fatty acids having, in each case, from 10 to 18 carbon atoms, for example lauric acid (n-dodecanoic acid), myristic acid (n-tetradecanoic acid), palmitic acid (n-hexadecanoic acid), stearic acid (n-octa-decanoic acid) and oleic acid (9-dodecenoic acid).

These anhydrides are prepared by methods with which those skilled in the art are familiar. A preferred method is the reaction of an acid chloride with an acid, with the hydrochloric acid liberated being driven off. Anhydrides can also be obtained by reaction of two fatty acid molecules with a strong mineral acid. If two different fatty acids are used here, a mixture of symmetrical and unsymmetrical anhydrides is obtained.

In a preferred embodiment, the water-redispersible polymer powder composition comprises

a) from 60 to 99.9% by weight of one or more water-insoluble, film-forming base polymers based on homopolymers or copolymers of one or more monomers from the group consisting of vinyl esters of unbranched or branched alkylcarboxylic acids having from 1 to 15 carbon atoms, methacrylic esters and acrylic esters of alcohols having from 1 to 15 carbon atoms, vinylaromatics, olefins, dienes and vinyl halides,
b) from 0.1 to 30% by weight of one or more fatty acid anhydrides and
c) from 0 to 30% by weight of one or more protective colloids, in each case based on the total weight of the polymer powder composition.

Particular preference is given to polymer powder compositions containing from 0.1 to 10% by weight, in particular from 1 to 5% by weight, of fatty acid anhydride b).

Vinyl esters suitable for the base polymer a) are those of carboxylic acids having from 1 to 15 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of alpha-branched monocarboxylic acids having from 9 to 13 carbon atoms, for example VeoVa9® or VeoVa10® (trade names of Resolution). Particular preference is given to vinyl acetate.

Suitable methacrylic esters or acrylic esters are esters of unbranched or branched alcohols having from 1 to 15 carbon atoms, e.g. methyl acrylate, methyl methacrylate, ethyl acrylate, ethyl methacrylate, propyl acrylate, propyl meth-acrylate, n-butyl acrylate, n-butyl methacrylate, 2-ethylhexyl acrylate, norbornyl acrylate. Preference is given to methyl acrylate, methyl methacrylate, n-butyl acrylate and 2-ethylhexyl acrylate.

Examples of olefins and dienes are ethylene, propylene and 1,3-butadiene. Suitable vinylaromatics are styrene and vinyltoluene. A suitable vinyl halide is vinyl chloride.

If desired, from 0.05 to 50% by weight, preferably from 1 to 10% by weight, based on the total weight of the base polymer, of auxiliary monomers can additionally be copolymerized.

Examples of auxiliary monomers are ethylenically unsaturated monocarboxylic and dicarboxylic acids, preferably acrylic acid, methacrylic acid, fumaric acid and maleic acids; ethylenically unsaturated carboxamides and nitriles, preferably acrylamide and acrylonitrile; monoesters and diesters of fumaric acid and maleic acid, e.g. the diethyl and diisopropyl esters, and also maleic anhydride, ethylenically unsaturated sulphonic acids or their salts, preferably vinylsulphonic acid, 2-acrylamido-2-methylpropanesulphonic acid. Further examples are precross-linking comonomers such as multiply ethylenically unsaturated comonomers, for example divinyl adipiate, diallyl maleate, allyl methacrylate or triallyl cyanurate, or postcrosslinking comonomers, for example acrylamidoglycolic acid (AGA), methyl methacrylamidoglycolate (MMAG), N-methylolacrylamide (NMA), N-methylolmethacrylamide (NMMA), allyl N-methylolcarbamate, alkyl ethers such as the isobutoxy ether or ester of N-methylol-acrylamide, of N-methylolmethacrylamide and of allyl N-methylolcarbamate. Epoxide-functional comonomers such as glycidyl methacrylate and glycidyl acrylate are also suitable. Further examples are silicon-functional comonomers such as acryloxypropyltri(alkoxy)silanes and methacryloxypropyltri-(alkoxy)silanes, vinyltrialkoxysilanes and vinylmethyldialkoxysilanes, with, for example, methoxy, ethoxy and ethoxypropylene glycol ether radicals being able to be present as alkoxy groups. Mention may also be made of monomers having hydroxy or CO groups, for example hydroxyalkyl methacrylates and acrylates such as hydroxyethyl, hydroxypropyl or hydroxybutyl acrylate or methacrylate and also compounds such as diacetoneacrylamide and acetylacetoxyethyl acrylate or methacrylate.

Examples of suitable homopolymers and copolymers are vinyl acetate homopolymers, copolymers of vinyl acetate with ethylene, copolymers of vinyl acetate with ethylene and one or more further vinyl esters, copolymers of vinyl acetate with ethylene and acrylic esters, copolymers of vinyl acetate with ethylene and vinyl chloride, styrene-acrylic ester copolymers, styrene-1,3-butadiene copolymers, which may, if desired, additionally contain the auxiliary monomers mentioned.

Preference is given to vinyl acetate homopolymers;

copolymers of vinyl acetate with from 1 to 40% by weight of ethylene;
copolymers of vinyl acetate with from 1 to 40% by weight of ethylene and from 1 to 50% by weight of one or more further comonomers from the group consisting of vinyl esters having 1 to 15 carbon atoms in the carboxylic acid radical, e.g. vinyl propionate, vinyl laurate, vinyl esters of alpha-branched carboxylic acids having from 9 to 13 carbon atoms, e.g. VeoVa9®, VeoVa10®, VeoVa11®;
copolymers of vinyl acetate, from 1 to 40% by weight of ethylene and preferably from 1 to 60% by weight of acrylic esters of unbranched or branched alcohols having from 1 to 15 carbon atoms, in particular n-butyl acrylate or 2-ethylhexyl acrylate; and
copolymers comprising from 30 to 75% by weight of vinyl acetate, from 1 to 30% by weight of vinyl laurate or vinyl esters of an alpha-branched carboxylic acid having from 9 to 13 carbon atoms and also from 1 to 30% by weight of acrylic esters of unbranched or branched alcohols having from 1 to 15 carbon atoms, in particular n-butyl acrylate or 2-ethylhexyl acrylate, and additionally from 1 to 40% by weight of ethylene; copolymers comprising vinyl acetate, from 1 to 40% by weight of ethylene and from 1 to 60% by weight of vinyl chloride; with the polymers being able to additionally contain the auxiliary monomers mentioned in the amounts mentioned and the percentages by weight in each case adding up to 100% by weight.

Preference is also given to (meth)acrylic ester polymers such as copolymers of n-butyl acrylate or 2-ethylhexyl acrylate or copolymers of methyl methacrylate with n-butyl acrylate and/or 2-ethylhexyl acrylate;

styrene-acrylic ester copolymers, preferably with one or more monomers from the group consisting of methyl acrylate, ethyl acrylate, propyl acrylate, n-butyl acrylate, 2-ethylhexyl acrylate;
vinyl acetate-acrylic ester copolymers, preferably with one or more monomers from the group consisting of methyl acrylate, ethyl acrylate, propyl acrylate, n-butyl acrylate, 2-ethylhexyl acrylate and, if desired, ethylene; styrene-1,3-butadiene copolymers; with the polymers being able to additionally contain the auxiliary monomers mentioned in the amounts mentioned and the percentages by weight in each case adding up to 100% by weight.

The choice of monomers and the choice of the proportions by weight of the comonomers are made so that a glass transition temperature Tg of from −50° C. to +50° C., preferably from −30° C. to +40° C., results. The glass transition temperature Tg of the polymers can be determined in a known manner by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n and Tgn is the glass transition temperature in kelvin of the homopolymer of the monomer n. Tg values for homopolymers are given in the Polymer Handbook 2nd Edition, J. Wiley & Sons, New York (1975).

The homopolymers and copolymers are prepared by the emulsion polymerization process or by the suspension polymerization process, preferably by the emulsion polymerization process, with the polymerization temperature generally being from 40° C. to 100° C., preferably from 60° C. to 90° C. The copolymerization of gaseous comonomers such as ethylene, 1,3-butadiene or vinyl chloride can also be carried out under superatmospheric pressure, generally in the range from 5 bar to 100 bar.

The polymerization is initiated by means of the water-soluble or monomer-soluble initiators or redox initiator combinations customary for emulsion polymerization or suspension polymerization. Examples of water-soluble initiators are the sodium, potassium and ammonium salts of peroxodisulphuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide and azobis-isobutyronitrile. Examples of monomer-soluble initiators are dicetyl peroxydicarbonate, dicyclohexyl peroxydicarbonate, dibenzoyl peroxide. The initiators mentioned are generally used in an amount of from 0.001 to 0.02% by weight, preferably from 0.001 to 0.01% by weight, in each case based on the total weight of the monomers.

As redox initiators, use is made of combinations of the above-mentioned initiators in combination with reducing agents. Suitable reducing agents are the sulphites and bisulphites of the alkali metals and of ammonium, for example sodium sulphite, the derivatives of sulphoxyl acid such as zinc or alkali metal formaldehyde sulphoxylates, for example sodium hydroxymethane-sulphinate, and ascorbic acid. The amount of reducing agent is generally from 0.001 to 0.03% by weight, preferably from 0.001 to 0.015% by weight, in each case based on the total weight of the monomers.

To control the molecular weight, regulating substances can be used during the polymerization. If regulators are used, they are usually used in amounts of from 0.01 to 5.0% by weight, based on the monomers to be polymerized, and are introduced separately or premixed with reaction components. Examples of such substances are n-dodecyl mercaptan, tert-dodecyl mercaptan, mercaptopropionic acid, methyl mercatopropionate, isopropanol and acetaldehyde.

Suitable protective colloids c) for the polymerization are polyvinyl alcohols; polyvinyl acetals; polyvinylpyrrolidones; polysaccharides in water-soluble form, e.g. starches (amylose and amylopectin), celluloses and their carboxymethyl, methyl, hydroxyethyl, hydroxypropyl derivatives; proteins such as casein or caseinate, soya protein, gelatin; lignosulphonates; synthetic polymers such as poly(meth)acrylic acid, copolymers of (meth)acrylates with carboxyl-function comonomer units, poly(meth)acrylamide, polyvinylsulphonic acids and their water-soluble copolymers; melamine formaldehyde sulphonates, napthalene formaldehyde sulphonates, styrene-maleic acid and vinyl ether-maleic acid copolymers.

Preference is given to partially hydrolysed or fully hydrolysed polyvinyl alcohols having a degree of hydrolysis of from 80 to 100 mol %, in particular partially hydrolysed polyvinyl alcohols having a degree of hydrolysis of from 80 to 95 mol % and a Höppler viscosity in 4% strength aqueous solution of from 1 to 30 mPas (Höppler method at 20° C., DIN 53015). Preference is also given to partially hydrolysed, hydrophobically modified polyvinyl alcohols having a degree of hydrolysis of from 80 to 95 mol % and a Höppler viscosity in 4% strength aqueous solution of from 1 to 30 mPas. Examples are partially hydrolysed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 carbon atoms, dialkyl maleates and dialkyl fumarates, e.g. diisopropyl maleate and diisopropyl fumarate, vinyl chloride, vinyl alkyl ethers such as vinyl butyl ether, olefins such as ethene and decene. The proportion of hydro-phobic units is preferably from 0.1 to 10% by weight, based on the total weight of the partially hydrolysed polyvinyl alcohol. It is also possible to use mixtures of the polyvinyl alcohols mentioned.

The greatest preference is given to polyvinyl alcohols having a degree of hydrolysis of from 85 to 94 mol % and a Höppler viscosity in 4% strength aqueous solution of from 3 to 15 mPas (Höppler method at 20° C., DIN 53015). The protective colloids mentioned can be obtained by means of methods known to those skilled in the art and are generally added in a total amount of from 1 to 20% by weight, based on the total weight of the monomers, in the polymerization.

If the polymerization is carried out in the presence of emulsifiers, they are present in an amount of from 1 to 5% by weight, based on the amount of monomers. Suitable emulsifiers include anionic, cationic and also nonionic emulsifiers, for example anionic surfactants such as alkylsulphates having a chain length of from 8 to 18 carbon atoms, alkyl or alkylaryl ether sulphates having from 8 to 18 carbon atoms in the hydro-phobic radical and up to 40 ethylene oxide or propylene oxide units, alkylsulphonates or alkylarylsulphonates having from 8 to 18 carbon atoms, esters and monoesters of sulphosuccinic acid with monohydric alcohols or alkylphenols, or nonionic surfactants such as alkyl polyglycol ethers or alkylaryl polyglycol ethers having from 8 to 40 ethylene oxide units.

After the polymerization, an after-polymerization can be carried out using known methods to remove residual monomers, generally by means of an after-polymerization initiated by a redox catalyst. Volatile residual monomers can also be removed by means of distillation, preferably under reduced pressure, and, if appropriate, with inert entrainer gases such as air, nitrogen or steam being passed over or through the polymerization mixture. The aqueous dispersions which can be obtained in this way have a solids content of from 30 to 75% by weight, preferably from 50 to 60% by weight.

To produce the water-redispersible polymer powder compositions, the fatty acid anhydride component b) is mixed in any desired way with the aqueous dispersion of the polymer a) and the dispersion is subsequently dried. Drying is carried out, for example, by means of fluidized-bed drying, freeze drying or spray drying. Preference is given to spray drying. Spray drying is carried out in conventional spray drying units, with atomization being able to be carried out by means of single-fluid, two-fluid or multifluid nozzles or a rotary atomizer disc. The outlet temperature is generally set in the range from 45° C. to 120° C., preferably from 60° C. to 90° C., depending on the unit, the Tg of the resin and the desired degree of drying.

Furthermore, protective colloids c) can additionally be used as drying aids in the production of the water-redispersible polymer powder compositions. The group of suitable drying aids is the same as the abovementioned group of protective colloids c) for the polymerization. The polymer powder composition preferably contains from 1 to 30% by weight of protective colloid c), based on its total weight.

In spray drying, a content of up to 1.5% by weight of antifoam, based on the base polymer, has frequently been found to be advantageous.

The viscosity of the feed to be atomized is set via the solids content so that a value of <1000 mPas (Brookfield viscosity at 20 revolutions and 23° C.), preferably <350 mPas, is obtained. The solids content of the dispersion to be atomized is >30%, preferably >40%.

In a further preferred embodiment, the water-redispersible polymer powder compositions do not contain any polymer component a), but instead comprise

b) from 5 to 70% by weight of one or more fatty acid anhydrides and
c) from 30 to 95% by weight of one or more protective colloids, in each case based on the total weight of the polymer powder composition.

To produce this embodiment, the fatty acid anhydride is generally mixed with an aqueous solution of the protective colloid and the mixture is subsequently dried, preferably spray dried. Suitable and preferred fatty acid anhydrides, suitable and preferred protective colloids and suitable and preferred drying methods correspond to the embodiments mentioned above.

Regardless of the composition of the water-redispersible polymer powder compositions, further additives can be added during drying to improve the use properties. Further constituents of the polymer powder compositions which are present in preferred embodiments are, for example, antifoams, pigments, foam stabilizers.

Further constituents of the water-redispersible polymer powder compositions which are present in preferred embodiments are organic and inorganic additives. Possible additives, which are not, however, restricted to the compounds mentioned below, can be: antifoams, inorganic or mineral antiblocking agents or fillers, the additives can each be present in an amount of up to 50% by weight, preferably up to 30% by weight, particularly preferably up to 20% by weight, based on the total weight of the water-redispersible polymer powder compositions. Antifoams are usually present in the water-redispersible polymer powder compositions in a proportion of up to 5% by weight.

It is also possible for inorganic or mineral compounds to be present in the water-redispersible polymer powder composition, preferably in a proportion of from 5 to 30% by weight. These inorganic additives improve the storability of the polymer powder composition by improving the blocking stability, in particular in the case of powders having a low glass transition temperature. Examples of customary antiblocking agents (anticaking agents) are Ca or Mg carbonate, talc, gypsum, silica, kaolins, silicates having particle sizes of preferably from 10 nm to 100 μm.

The water-redisperisble polymer powder compositions can be used in the fields of application typical of them. They can be used either alone or in combination with conventional redispersion powders. They can be used, for example, in building chemical products, if appropriate in combination with hydraulically setting binders such as cements (portland cement, alumina cement, pozzolanic cement, slag cement, magnesia cement, phosphate cement), gypsum plaster and water glass, for the production of building adhesives, in particular tile adhesives and thermal insulation adhesives, plasters and renders, scim coat, knifing fillers, flooring compositions, self-levelling screeds, sealing slurries, jointing mortars and paints. Further applications are gunned mortar and gunned concrete for building and construction and also for the lining of tunnel walls. The water-redispersible polymer powder compositions can also be used as hydrophobicizing agents for sand, clay, paper, textiles, natural or synthetic fibres. The water-redispersible polymer powder compositions can also be used to modify or coat surfaces, for example in coating and varnish applications.

Surprisingly, better hydrophobicization properties are obtained by means of these polymer powder compositions than by means of the more mobile fatty acid ester derivatives or the acids which are directly present in the aqueous phase. Although the fatty acid anhydrides are less water-soluble and also less mobile in order to migrate from the organic polymer to the interface and to hydrolyse, excellent hydrophobicizing properties are nevertheless obtained. An advantage here is found to be that one molecule of anhydride gives two molecules of fatty acid salt which are each active. A further advantage is that no emission-relevant compounds are formed.

### EXAMPLES

### Powders

The powders were produced by spray drying a polyvinyl alcohol-stabilized dispersion of an ethylene-vinyl acetate copolymer with addition of 6% by weight of a polyvinyl alcohol having a degree of hydrolysis of 88 mol % and a Höppler viscosity of 4 mPas and with addition of the fatty acid derivative in the amounts indicated.

The dispersion was then sprayed by means of a two-fluid nozzle. Air which had been precompressed to 4 bar served as atomizing component, and the droplets formed were dried in cocurrent by means of air heated to 125° C. The dry powder obtained was admixed with 10% by weight of commercial antiblocking agent (calcium magnesium carbonate).

Powder P1: containing 1% by weight of lauric anhydride
Powder P2: containing 4% by weight of lauric anhydride
Powder P3: containing 1% by weight of palmitic anhydride
Powder P4: containing 2% by weight of a mixed anhydride of lauric acid and acetic acid
Comparative powder P5: containing 1% by weight of methyl laurate as hydrophobicizing agent
Comparative powder P6: containing 4% by weight of methyl laurate as hydrophobicizing agent

### Testing:

### Determination of the Hydrophobicity:

To determine the hydrophobicity, a mineral composition was made up from 30% by weight of cement, 68% by weight of sand and 2% by weight of dispersion powder. After addition of water, a test specimen was produced and dried. A drop of water was then placed on this test specimen by means of a pipette and the time for which this drop remained on the surface was measured.

TABLE 1

| Example | t/min |
|---|---|
| Powder P1 | 130 |
| Powder P2 | 450 |
| Powder P3 | 110 |
| Powder P4 | 105 |
| Comparative powder P5 | 100 |
| Comparative powder P6 | 420 |

It can be seen from the data that the hydrophobicization achieved using the product according to the invention is clearly superior to that obtained using the standard products.

1.-11. (canceled)

12. A composition of matter comprising a water-redispersible polymer powder composition comprising from 0.1 to 70% by weight of one or more fatty acid anhydrides, based on the total weight of the water-redispersible polymer powder composition.

13. The composition of matter of claim 12, wherein the water-redispersible polymer powder composition comprises one or more fatty acid anhydrides of branched or unbranched, saturated or unsaturated fatty acids having from 8 to 22 carbon atoms.

14. The composition of matter of claim 13, wherein the water-redispersible polymer powder composition comprises unsymmetrical fatty acid anhydrides.

15. The composition of matter of claim 14, wherein the water-redispersible polymer powder composition comprises unsymmetrical fatty acid anhydrides of fatty acids having from 8 to 22 carbon atoms and carboxylic acids having from 2 to 6 carbon atoms.

16. The composition of matter of claim 12, wherein the water-redispersible polymer powder composition comprises symmetrical fatty acid anhydrides of saturated or unsaturated fatty acids having from 10 to 18 carbon atoms.

17. The composition of matter of claim 12, wherein the water-redispersible polymer powder composition comprises
a) from 60 to 99.9% by weight of one or more water-insoluble, film-forming base polymers based on homopolymers or copolymers of one or more monomers comprising vinyl esters of unbranched or branched alkylcarboxylic acids having from 1 to 15 carbon atoms, methacrylic esters and acrylic esters of alcohols having from 1 to 15 carbon atoms, vinylaromatics, olefins, dienes and vinyl halides,
b) from 0.1 to 30% by weight of one or more fatty acid anhydrides and
c) from 0 to 30% by weight of one or more protective colloids, the percentages by weight based on the total weight of the water-redispersible polymer powder composition.

18. The composition of matter of claim 12, wherein the water-redispersible polymer powder composition comprises:
a) from 5 to 70% by weight of one or more fatty acid anhydrides and
b) from 30 to 95% by weight of one or more protective colloids,
the weight percentages based on the total weight of the polymer powder composition.

19. A process for producing a composition of matter comprising a water-redispersible polymer powder composition of claim 12, comprising (1) drying a mixture comprising an aqueous dispersion of a polymer a) and a fatty acid anhydride b), or (2) drying only fatty acid anhydride b), in the first case (1), optionally in the presence of a protective colloid c), and in the second case (2), in the presence of a protective colloid c).

20. The composition of matter of claim 12, further comprising at least one hydraulically setting binder.

21. In a building adhesive, tile adhesive, thermal insulation adhesive, plaster or render, scim coat, knifing filler, flooring composition, self-leveling screed, sealing slurry, jointing mortar, paint, gunned mortar or gunned concrete, containing a polymer powder and at least one hydraulic setting inorganic binder, the improvement comprising substituting the water-redispersible polymer powder composition of matter of claim 12 for all or part of the redispersible polymer powder.

22. A process for hydrophobicizing sand, clay, paper, textile, natural or synthetic fibres, comprising applying a hydrophobicizing amount of the composition of matter of claim 12.

23. A process for hydrophobicizing sand, clay, paper, textile, natural or synthetic fibres, comprising applying a hydrophobicizing amount of the composition of matter of claim 18.

24. A chemical building construction composition, comprising
a) at least one hydraulically setting inorganic binder,
b) at least one redispersible polymer powder, and
c) the water-redispersible polymer powder of claim 18.
